(19) United States
(12) Patent Application Publication
(10) Pub. No.: US 2025/0247672 A1
(43) Pub. Date: Jul. 31, 2025

(54) APPARATUS AND METHOD FOR PRECISE POSITIONING BASED ON CELL ID OF MOBILE COMMUNICATION BASE STATION

(71) Applicant: Electronics and Telecommunications Research Institute, Daejeon (KR)

(72) Inventors: Jin Ah Kang, Daejeon (KR); Youngsu Cho, Daejeon (KR)

(21) Appl. No.: 19/009,867

(22) Filed: Jan. 3, 2025

(30) Foreign Application Priority Data
Jan. 29, 2024 (KR) 10-2024-0013103

(51) Int. Cl. H04W 4/029; G06N 3/08

(52) U.S. Cl. CPC H04W 4/029; G06N 3/08

(57) ABSTRACT

A precise positioning method is provided. The precise positioning method includes a step of receiving a serving cell identifier (ID) from a mobile communication terminal by using a communication device, a step of analyzing the serving cell ID to infer a neighboring cell ID by using a neighboring cell inference model, and a step of analyzing the neighboring cell ID to infer a position of the mobile communication terminal by using a precise position inference model.

### CROSS-REFERENCE TO RELATED APPLICATIONS

This application claims the benefit of the Korean Patent Application No. 10-2024-0013103 filed on Jan. 29, 2024, which is hereby incorporated by reference as if fully set forth herein.

### BACKGROUND

### Field of the Invention

The present disclosure relates to positioning technology for measuring a position of a positioning target object such as a mobile communication terminal.

### Discussion of the Related Art

Positioning technology is technology for measuring a position of a positioning target object and is being used in various fields such as a local based service (LBS), navigation, emergency rescue work, industrial automation, military purpose, and data collection.

Global positioning system (GPS)-based positioning technology widely used at present has an advantage of providing an accurate positioning result in an outdoor environment, but has a disadvantage in that positioning is impossible in an indoor environment, or an inaccurate positioning result is provided.

Positioning technology based on wireless communication infrastructure such as Wi-Fi/Bluetooth has an advantage of providing an accurate positioning result by using a multiple access point and the intensity of a wireless signal in an indoor environment, but has a disadvantage in that positioning is impossible in an environment including no wireless communication infrastructure.

Positioning technology based on a mobile communication base station has an advantage where positioning is possible anywhere without a limitation of an indoor/outdoor environment, but has a disadvantage in that an accuracy of positioning is lower than GPS-based positioning technology.

Research on positioning technology for complementing the disadvantages of the positioning technologies is required.

### SUMMARY

An aspect of the present disclosure is directed to providing a precise positioning method and apparatus which may precisely measure a position of a positioning target object by using a deep learning model trained to infer the position of the positioning target object without a limitation of an indoor/outdoor environment and a wireless communication infrastructure, based on a cell identifier (ID) or a code of a mobile communication base station received from the positioning target object.

To achieve these and other advantages and in accordance with the purpose of the invention, as embodied and broadly described herein, there is provided a precise positioning method performed by a precise positioning apparatus, the precise positioning method including: a step of receiving a serving cell identifier (ID) from a mobile communication terminal by using a communication device; a step of analyzing the serving cell ID to infer a neighboring cell ID by using a neighboring cell inference model; and a step of analyzing the neighboring cell ID to infer a position of the mobile communication terminal by using a precise position inference model.

In another aspect of the present invention, there is provided a training method of a deep learning model performed by a model training device and including a neighboring cell inference model and a precise position inference model inferring a position of a mobile communication terminal from a serving cell identifier (ID) received from the mobile communication terminal, the training method including: a step of receiving a training data set from a data collection device moving by using a communication device of the model training device; a step of training the neighboring cell inference model to infer a neighboring cell ID from a serving cell ID by using a first training module of the model training device, based on the serving cell ID and the neighboring cell ID included in the training data set; and a step of training the precise position inference model to infer a position of the mobile communication terminal from the neighboring cell ID by using a second training module of the model training device, based on a serving cell ID, a neighboring cell ID, and a mobile network code of a mobile communication base station accessed by the data collection device and included in the training data set and a latitude or longitude value representing a current position of the data collection device.

In another aspect of the present invention, there is provided a precise positioning apparatus including: a processor; a communication device configured to receive a serving cell identifier (ID) from a mobile communication terminal, based on control by the processor; a storage device configured to store a neighboring cell inference model analyzing the serving cell ID to infer a neighboring cell ID and a precise position inference model analyzing the neighboring cell ID to infer a position of the mobile communication terminal, based on execution of the processor.

The present invention may infer neighboring cell IDs (or neighboring cell ID sequence) of a plurality of neighboring cells neighboring to a cell accessed by a positioning target object in a first inference process of a deep learning model, based on a cell ID of a cell accessed by the positioning target object, and may infer a position of the positioning target object in a second inference process of the deep learning model, based on the inferred neighboring cell IDs (neighboring cell ID sequence).

As described above, the present invention may precisely infer the position of the positioning target object by using a cell ID of the deep learning model, and thus, may very easily and conveniently provide a precise positioning service without a limitation of an indoor/outdoor environment and a wireless communication infrastructure such as Wi-Fi/Bluetooth.

Moreover, the present invention may infer the position of the positioning target object by using only a cell ID which is minimized information, and thus, may very quickly provide the precise positioning service in an emergency disaster situation which is difficult to sufficiently obtain information needed for positioning of the positioning target object.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a schematic entire configuration diagram of a precise positioning system according to an embodiment of the present invention.

FIG. 2 is a diagram for describing a training data set according to an embodiment of the present invention.

FIG. 3 is a diagram for describing a process of generating a deep learning model performed by a model training device of FIG. 1.

FIG. 4 is a diagram for describing a processing process of a training data set and a structure of a neighboring cell inference model of FIG. 3.

FIG. 5 is a diagram for describing a processing process of a training data set and a structure of a precise position inference model of FIG. 3.

FIG. 6 is a flowchart for describing a precise positioning method according to an embodiment of the present invention.

FIG. 7 is a flowchart for describing a training method of a deep learning model (neighboring cell inference model and precise position inference model) performing precise positioning according to an embodiment of the present invention.

### DETAILED DESCRIPTION OF THE INVENTION

In the following description, the technical terms are used only for explaining a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

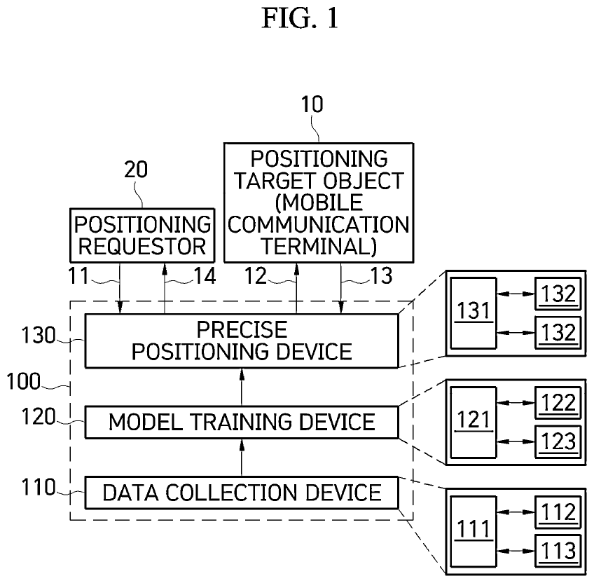

FIG. 1 is a schematic entire configuration diagram of a precise positioning system 100 according to an embodiment of the present invention.

Referring to FIG. 1, the precise positioning system 100 according to an embodiment of the present invention may include a data collection device 110, a model training device 120, and a precise positioning device 130.

The data collection device 110 may be a device which collects a training data set of a deep learning model for precise positioning of a positioning target object 10. The data collection device 110 may collect a training data set while moving, without a setting up additional positioning infrastructure. To this end, the data collection device 110 may be equipped in, for example, a bike, a vehicle, and a mobile communication terminal.

When the data collection device 110 is powered off, the collection of the training data set may end, and then, when the data collection device 110 is powered on, the data collection device 110 may transmit a previously collected training data set to the model training device 120 through a wireless communication scheme. At this time, the data collection device 110 may transmit the collected training data set to the model training device 120 via a separate proxy server (not shown in FIG. 1) which manages and distributes the collected training data set.

To collect and transmit the training data set, the data collection device 110 may include, for example, a processor 111, a memory 112, and a communication device 113. The processor 111 may be configured to include at least one central processing unit (CPU) which executes and controls a dedicated application for collecting the training data set. The memory 112 may be configured to include a volatile and/or non-volatile memory which temporarily and/or permanently stores instructions for execute and control the dedicated application. The processor 111 and the memory 112 may be integrated into one chip. The communication device 113 may transmit the collected training data set to the model training device 120 through a wireless communication scheme, based on control by the processor 111. The wireless communication scheme may include, for example, mobile communication and/or Wi-Fi such as 3^{rd} Generation (3G), 4^{th} Generation (4G), long term evolution (LTE), and 5^{th} Generation (5G) and short-range wireless communication such as Bluetooth.

The model training device 120 may be a computing device which trains (learns) a deep learning model for precise positioning of a positioning target object, based on the training data set received from the data collection device 110. For example, the model training device 120 may be implemented with a terminal, a desktop, or a server.

When training (learning) of the deep learning model is completed, the model training device 120 may transmit the deep learning model to the precise positioning device 130 through a wired and/or wireless communication scheme, and thus, the deep learning model may be loaded into the precise positioning device 130.

The model training device 120 may be implemented with a portable terminal class, a desktop class, or server class computing device, for training (learning) of the deep learning model. The model training device 120 may include, for example, a processor 121, a memory 122, and a communication device 123. The processor 121 may include at least one CPU, at least one graphics processing unit (GPU), at least one model optimization unit (MOU), at least one neural processing unit (NPU), and/or an on device artificial intelligence (AI) chip, which execute(s) and control(s) a dedicated application for training (learning) of the deep learning model. The memory 122 may be configured to include a volatile and/or non-volatile memory which temporarily and/or permanently stores instructions for execute and control the dedicated application. The processor 121 and the memory 122 may be integrated into one chip. The communication device 123 may transmit the training (learning)-completed deep learning model to the model training device 120 through a wired and/or wireless communication scheme, based on control by the processor 121. The wireless communication scheme may include, for example, mobile communication and/or Wi-Fi such as 3G, 4G, LTE, and 5G and short-range wireless communication such as Bluetooth. In FIG. 1, the model training device 120 is illustrated as an independent element, but is not limited thereto and may be included in another element (for example, the precise positioning device 130).

The precise positioning device 130 may be a device which infers a position of the positioning target object 10 by using the deep learning model loaded from the model training device 120 and provides a positioning requestor 20 with position information (for example, a latitude and a longitude corresponding to the position of the positioning target object) about the positioning target object 10, which is a result of the inference. The positioning target object 10 may be a mobile communication terminal. Hereinafter, the positioning target object 10 may be referred to as a mobile communication terminal.

In detail, the positioning requestor 20 may transmit a positioning request message 11 to the precise positioning device 130. Here, the positioning requestor 20 may be a device which is possessed by another user (family, an acquaintance, or a relation of a user) associated with a user of the mobile communication terminal 10. The device possessed by the other user may be for example, a mobile communication terminal or a desktop possessed by the other user.

Subsequently, when the precise positioning device 130 receives the positioning request message 11 from the positioning requestor 20, the precise positioning device 130 may transmit an information request message 12, requesting information needed for precise positioning of the mobile communication terminal 10, to the mobile communication terminal 10.

Subsequently, the mobile communication terminal 10 may transmit, to the precise positioning device 130, a response message 13 configured to include a code of a mobile communication base station accessed by the mobile communication terminal 10 in response to the information request message 12. Here, the code of the mobile communication base station may include a cell identifier (CID) and/or a physical cell identifier (PCI) of a cell accessed by the mobile communication terminal 10. In this case, the cell accessed by the mobile communication terminal 10 may be referred to as a ‘serving cell’.

The code (PCI and/or CID) may be provided from the mobile communication base station to the mobile communication terminal 10, based on a rule defined in a mobile communication standard (for example, 3G, 4G, LTE, 5G, global system for mobile communication (GSM), etc.), and thus, the mobile communication terminal 10 may provide the code (PCI and/or CID) to the precise positioning device 130.

Subsequently, the precise positioning device 130 may analyze the code (PCI and/or CID) received from the mobile communication terminal 10 by using the previously trained (learned) deep learning model loaded from the model training device 120 to infer accurate position information about the mobile communication terminal 10 and may configure a response message 14 including the inferred position information to finally transfer the response message 14 to the positioning requestor 20.

As described above, the precise positioning device 130 according to an embodiment of the present invention may infer the position of the mobile communication terminal 10 by using only minimized information such as the code (PCI and/or CID) received from the mobile communication terminal 10, and thus, may very easily and conveniently provide a precise positioning service independently of an indoor/outdoor environment and a wireless communication infrastructure such as Wi-Fi/Bluetooth. Also, the precise positioning device 130 may very quickly provide the precise positioning service in an emergency disaster situation which is difficult to sufficiently obtain information needed for positioning of the positioning target object.

Furthermore, the precise positioning device 130 may be implemented with, for example, a portable terminal class, a desktop class, or server class computing device, for executing the deep learning model which infers the position of the mobile communication terminal 10 by using only a code (PCI and/or CID) of a mobile communication base station as an input.

The precise positioning device 130 may include, for example, a processor 131, a memory 132, and a communication device 133. The processor 131 may include at least one CPU, at least one GPU, at least one MOU, at least one NPU, and/or an on device AI chip, which execute(s) and control(s) a deep learning model. The memory 132 may be configured to include a volatile and/or non-volatile memory which temporarily and/or permanently stores instructions for execute and control the deep learning model. The processor 131 and the memory 132 may be integrated into one chip. The communication device 133 may receive information (for example, a cell ID (a serving cell ID), a neighboring cell ID, or a code of a mobile communication base station), needed for inferring of the position of the mobile communication terminal 10, from the mobile communication terminal 10, based on control by the processor 131. Also, the communication device 133 may receive a deep learning model generated by the model training device 120. Also, the communication device 133 may transmit, to the positioning requestor 20, position information (for example, a latitude value and a longitude value) about the mobile communication terminal 10 inferred by the deep learning model through a wireless communication scheme. The wireless communication scheme may include, for example, mobile communication and/or Wi-Fi such as 3G, 4G, LTE, and 5G and short-range wireless communication such as Bluetooth. Also, although not shown in FIG. 1, the precise positioning device 130 may further include a storage device which stores the deep learning model received from the model training device 120.

Hereinafter, a training data set collected by the data collection device 110 and a deep learning model trained (learned) and executed by the model training device 120 and the precise positioning device 130 will be described in detail.

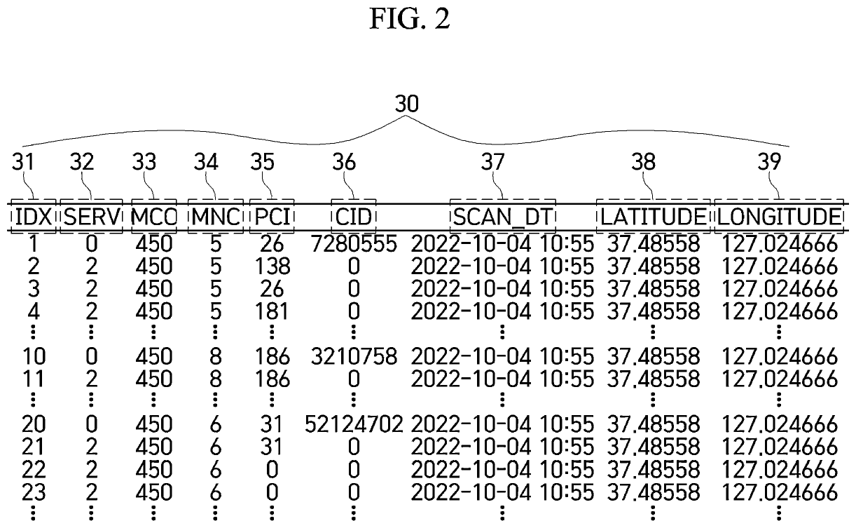

FIG. 2 is a diagram for describing a training data set according to an embodiment of the present invention.

Referring to FIG. 2, a deep learning model trained (learned) and executed by the model training device 120 and the precise positioning device 130 may be previously trained (learned) based on a training data set 30 to infer position information about the mobile communication terminal 10 by using only a code (PCI and/or CID) of a base station as an input.

The training data set 30 may include an index (IDX) 31, a serving cell (SERV) factor 32, a mobile country code (MCC) 33, a mobile network code (MNC) 34, a physical cell ID (PCI) 35, a cell ID (CID) 36, a SCAN_DT 37, a latitude (LATITUDE) 38, and a longitude (LONGITUDE) 39.

The IDX 31 may be a turn of data collected by the data collection device 110. The SERV factor 32 may be a value of differentiating a cell (i.e., a serving cell) accessed by the mobile communication terminal 10 from a neighboring cell of the serving cell, and for example, the serving cell may be referred to by ‘0 (zero)’, and the neighboring cell may be referred to by ‘2’. The MCC 33 may be a mobile country code. The MNC 34 may be a mobile network code. The PCI 35 may be a cell ID which is assigned based on a physical position of the serving cell or the neighboring cell. The CID 36 may be a unique cell ID of the serving cell or the neighboring cell regardless of the physical position of the serving cell or the neighboring cell. In this case, in the neighboring cell, the CID may be referred to by ‘0 (zero)’. Therefore, when a SERV is ‘0’ and a CID is not ‘0’, the CID may denote a CID of the serving cell. The SCAN_DT 37 may be year/month/day/time obtained by collecting data. The LATITUDE 38 may be a latitude of a point at which the data collection device 110 is located at a time at which the data is collected. The LONGITUDE 39 may be a longitude of a point at which the data collection device 110 is located at a time at which the data is collected.

The training data set 30 may be grouped with a cell ID on the same position (the same latitude value and longitude value), and then, may be used in training of models.

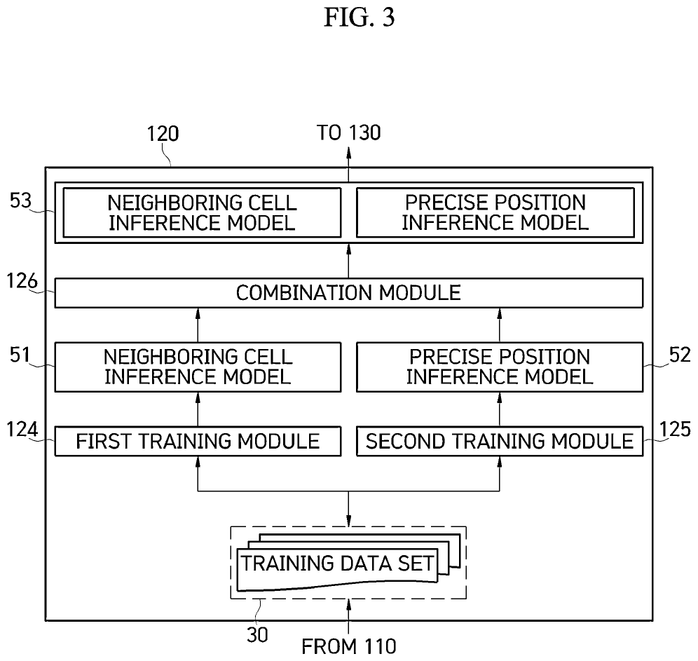

FIG. 3 is a diagram for describing a process of generating a deep learning model performed by the model training device 120 of FIG. 1.

Referring to FIG. 3, the model training device 120 may generate a deep learning model 53 which infers a precise position of the mobile communication terminal 10, based on only code information (for example, PCI or CID) about a mobile communication base station, and may transfer the deep learning model 53 to the precise positioning device 130.

To this end, the model training device 120 may include a first training module 124, a second training module 125, and a combination module 126. The modules 124 to 126 may be merely for dividing by function units so as to help understand description, and the present invention is not limited thereto. Depending on the case, the first training module 124 and the second training module 125 may be integrated into one module, or all of the modules 124 to 126 may be integrated into one module.

The first training module 124 may generate a trained (learned) neighboring cell inference model 51 by using a training data set (30 of FIG. 2) collected by the data collection device 110. Here, the neighboring cell inference model 51 trained (learned) by the training data set 30 may be configured to include a deep learning network which analyzes a cell ID (hereinafter referred to as a serving cell ID) of a cell (hereinafter referred to as a serving cell) accessed by a mobile communication terminal to infer cell IDs (hereinafter referred to as neighboring cell IDs or a neighboring cell ID sequence including neighboring cell IDs) of neighboring cells.

For example, the first training module 124 may analyze a relationship between a serving cell ID (PCI or CID of a serving cell) included in the training data set 30 and neighboring cell IDs (PCIs or CIDs of neighboring cells). Subsequently, the first training module 124 may set input data which is an input feature value needed for training (learning) of the neighboring cell inference model 51 and output data which is target data (a target label). Subsequently, the first training module 124 may repeatedly input the set input/output data to the deep learning network of the neighboring cell inference model 51 by batch units, may end training (learning) at an appropriate time, based on the bias-variance trade off of the neighboring cell inference model 51, and may generate the neighboring cell inference model 51 through a method which stores a structure, a weight, and a bias value of the neighboring cell inference model 51.

The second training module 125 may generate a trained (learned) precise position inference model 52 by using the training data set (30 of FIG. 2). Here, the precise position inference model 52 trained (learned) by the training data set 30 may be configured to include a deep learning network which analyzes neighboring cell IDs inferred by the neighboring cell inference model 51 to infer a precise position of the mobile communication terminal 10.

For example, the second training module 125 may analyze a relationship between a precise position and neighboring cell IDs (including a serving cell ID) included in the training data set 30. Subsequently, the second training module 125 may set input data which is an input feature value needed for training (learning) of the precise position inference model 52 and output data which is target data (a target label). Subsequently, the second training module 125 may repeatedly input the set input/output data to the deep learning network of the precise position inference model 52 by batch units, may end training (learning) at an appropriate time, based on the bias-variance trade off of the precise position inference model 52, and may generate the precise position inference model 52 through a method which stores a structure, a weight, and a bias value of the precise position inference model 52.

When the neighboring cell inference model 51 and the precise position inference model 52 are respectively generated by the first training module 124 and the second training module 125, the combination module 126 may concatenate an output of the neighboring cell inference model 51 with an input of the precise position inference model 52 to generate the deep learning model 53, and then, may transfer the deep learning model 53 to the precise positioning device 130.

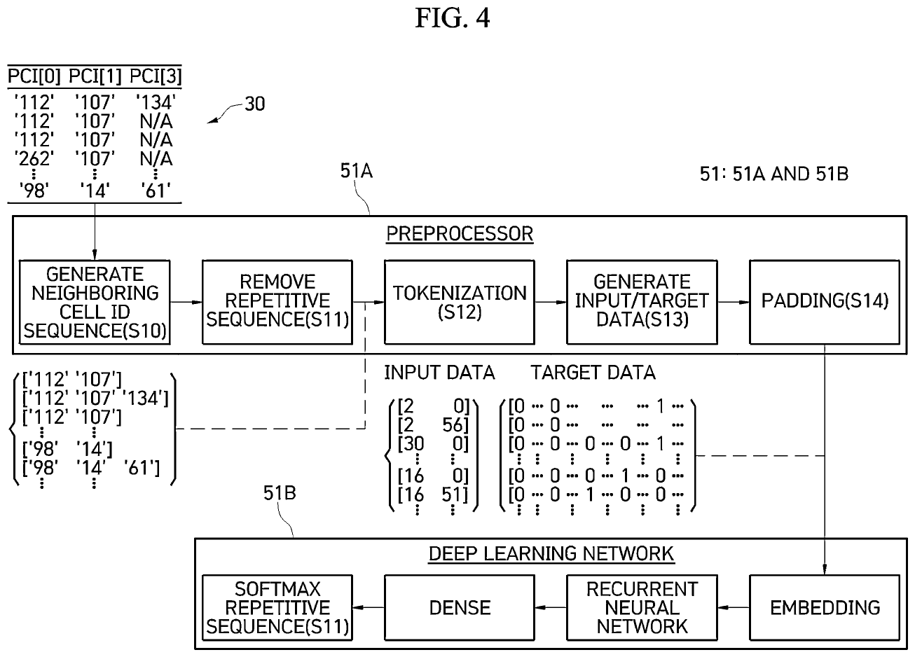

FIG. 4 is a diagram for describing a processing process of a training data set and a structure of the neighboring cell inference model 51 of FIG. 3.

Referring to FIG. 4, the neighboring cell inference model 51 may be configured to include a data preprocessor 51A and a deep learning network 51B based on a recurrent neural network (RNN). Here, the data preprocessor 51A may not be included in the neighboring cell inference model 51 and may be disposed at a previous end of the neighboring cell inference model 51. In this case, the neighboring cell inference model 51 may be construed as including only the deep learning network 51B.

First, in step S10, the data preprocessor 51A may refine the training data set 30 to generate a neighboring cell ID sequence. For example, ‘112’, ‘107’, and ‘134’ which are a neighboring cell ID list on the same position included in the training data set 30 may be generated as two sequences consisting of [‘112’, ‘107’] and [‘112’, ‘107’, ‘134’].

Subsequently, in step S11, the data preprocessor 51A may remove repetitive sequences of the generated neighboring cell ID sequences.

Subsequently, in step S12, the data preprocessor 51A may tokenize neighboring cell ID sequences from which the repetitive sequences have been removed. Here, tokenization may denote that all neighboring cell IDs configuring each sequence are converted from character-type data into integer-type data.

Subsequently, in step S13, the data preprocessor 51A may separate neighboring cell IDs, converted into integer-type data through a tokenization process, into matrix-type input data and target data and may convert the data into a type suitable for deep learning through padding. As illustrated in FIG. 4, the input data may be a cell ID matrix tokenized as an integer type having the same length, and the target data may be a one-hot encoded target cell ID matrix. In this case, sizes of the input data and the target data of the deep learning network 51B will be described below.

Input data size (Input_Size)=batch size (Batch_Size)×maximum number of neighboring cell (Max_NeighborCell_Number) observed in training data set 30

Target data size (Output_Size)=batch size (Batch_Size)×number of cell IDs (Total_Cell_Number) observed in training data set 30

The deep learning network 51B may be configured to include an embedding layer, a recurrent neural network, a dense layer, and a softmax layer. The recurrent neural network may be configured with a long short-term memory (LSTM) and a gated recurrent unit (GRU), in addition to the RNN. When a neighboring cell (a target label) is allowed in plurality, an objective function for model training may be set to binary cross-entropy, and when only one neighboring cell is allowed, the objective function may be set to categorical cross-entropy. In addition, a model parameter requiring a setting may include the number of embedding dimensions (or an embedding size), the number of hidden layers, a learning rate, a batch size, and the number of epochs.

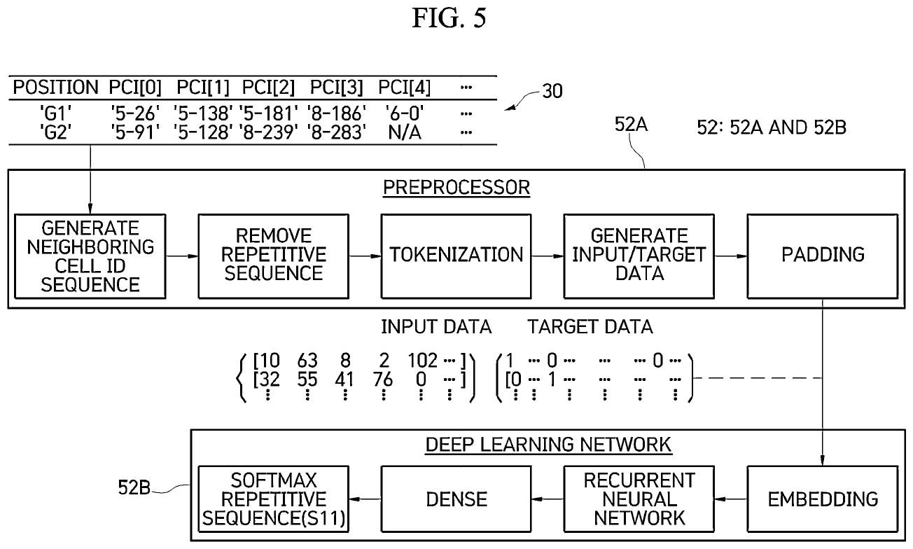

FIG. 5 is a diagram for describing a processing process of the training data set 30 and a structure of the precise position inference model 52 of FIG. 3.

Referring to FIG. 5, similarly to the neighboring cell inference model 51, the precise position inference model 52 may be configured to include a data preprocessor 52A and an RNN-based deep learning network 52B. Here, the data preprocessor 52A may not be included in the neighboring cell inference model 51 and may be disposed at a previous end of the precise position inference model 52. In this case, the precise position inference model 52 may be construed as including only the deep learning network 51B.

The data preprocessor 52A may first refine the training data set 30 to generate a neighboring cell ID on the same position. For example, as illustrated in FIG. 5, the data preprocessor 52A may convert a latitude/longitude value included in the training data set 30 into a grid code like ‘G1’ and ‘G2’ and may preprocess a neighboring cell ID included in the training data set 30 into data (for example, MNC-PCI) which is a combination of a mobile network code (MNC) and a cell ID (PCI or CID), like ‘5-26’, ‘5-138’, ‘5-181’, ‘8-186’, and ‘6-0’.

The data preprocessor 52A may generate a neighboring cell ID sequence by using the refined data set and may remove a repetitive sequence. The generated sequences may be converted into integer-type data through a tokenization process, may be separated into an input data matrix and a target data matrix, and may be padded. Therefore, as illustrated in FIG. 5, the sequence may be converted into a type suitable for deep learning. That is, the input data may be converted into a cell ID matrix tokenized as an integer type having the same length, and the target data may be converted into a one-hot encoded target position grid matrix. Accordingly, sizes of the input data and the target data, which is output data, of the deep learning network 52B will be described below.

Input data size (Input_Size)=batch size (Batch_Size)×maximum number of neighboring cell (Max_NeighborCell_Number) observed in data set

Target data size (Output_Size)=batch size (Batch_Size)×position (position converted into grid type) (Total_Grid_Number) observed in data set

The deep learning network 52B may be configured with an embedding layer, a recurrent neural network, a dense layer, and a softmax layer. The recurrent neural network may be configured with LSTM and GRU, in addition to the RNN. An objective function for model training may be set to categorical cross-entropy. In addition, a model parameter requiring a setting may include the number of embedding dimensions (or an embedding size), the number of hidden layers, a learning rate, a batch size, and the number of epochs.

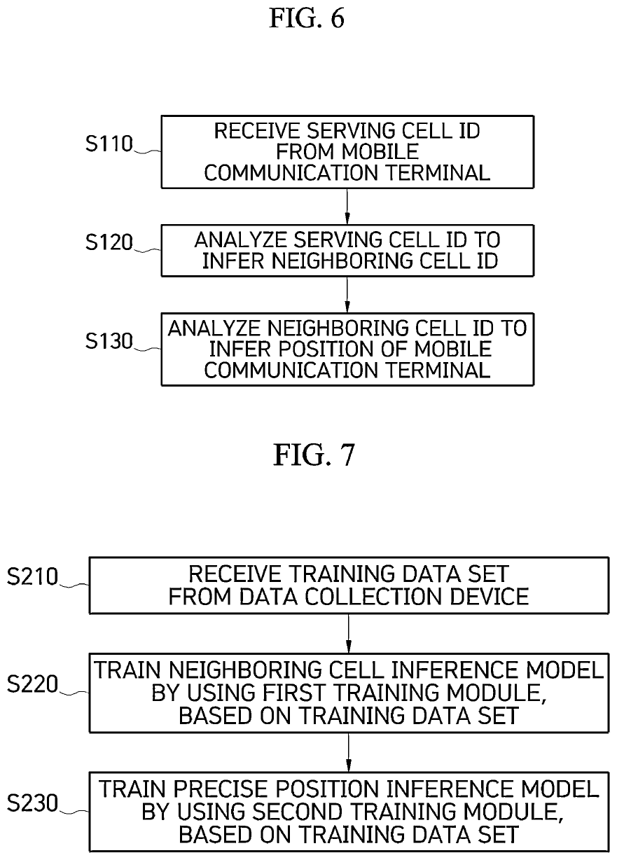

FIG. 6 is a flowchart for describing a precise positioning method performed by a precise positioning apparatus, according to an embodiment of the present invention.

Referring to FIG. 6, first, in step S110, a step of receiving a serving cell ID or a code of a mobile communication base station, accessed by the mobile communication terminal 10, from the mobile communication terminal 10 by using the communication device 133 may be performed.

Subsequently, in step S120, a step of analyzing the serving cell ID (PCI or CID) to infer a neighboring cell ID by using the neighboring cell inference model 51 executed by the processor 31 may be performed.

Subsequently, in step S130, a step of analyzing the neighboring cell ID to infer a position of the mobile communication terminal 10 by using the precise position inference model 52 executed by the processor 131 may be performed.

In an embodiment, the neighboring cell inference model 51 may include a deep learning network which has previously learned a relationship between the serving cell ID and the neighboring cell ID.

In an embodiment, the precise position inference model 52 may include a deep learning network which has previously learned a relationship between the neighboring cell ID and a precise position of the mobile communication terminal.

In an embodiment, a step of preprocessing the serving cell ID may be further performed between step S110 and step S120.

In an embodiment, the preprocessing step may include a step of converting the serving cell ID from character-type data into integer-type data through a tokenization process, a step of adjusting a size of the integer-type data through a padding process, and a step of inputting the size-adjusted integer-type data to the neighboring cell inference model 51.

In an embodiment, step S120 may include a step of analyzing the size-adjusted integer-type data to obtain a neighboring cell ID token which is highest in right answer probability and a step of obtaining the neighboring cell ID from the neighboring cell ID token through a reverse tokenization process.

In an embodiment, a step of preprocessing the neighboring cell ID may be further performed between step S120 and step S130.

In an embodiment, the step of preprocessing the neighboring cell ID may include a step of converting the neighboring cell ID from character-type data into integer-type data through a tokenization process, a step of adjusting a size of the integer-type data through a padding process, and a step of inputting the size-adjusted integer-type data to the precise position inference model.

In an embodiment, step S130 may include a step of analyzing the size-adjusted integer-type data to obtain a grid code token which is highest in right answer probability, a step of obtaining a grid code from the grid code token through a reverse tokenization process, and a step of converting the grid code into a position of the mobile communication terminal including a latitude value and a longitude value through a data post-processing process.

FIG. 7 is a flowchart for describing a training method of a deep learning model (neighboring cell inference model and precise position inference model) performing precise positioning according to an embodiment of the present invention.

Referring to FIG. 7, first, in step S210, a step of receiving a training data set (30 of FIG. 2) from the data collection device 110 moving by using the communication device 123 of the model training device 120 may be performed.

Subsequently, in step S220, a step of training the neighboring cell inference model 51 to infer a neighboring cell ID from a serving cell ID by using the first training module 124 of the model training device 120, based on the serving cell ID and the neighboring cell ID included in the training data set 30, may be performed.

Subsequently, in step S230, a step of training the precise position inference model 52 to infer a position of the mobile communication terminal 10 from the neighboring cell ID by using the second training module 125 of the model training device 120, based on a serving cell ID, a neighboring cell ID, and a mobile network code of a mobile communication base station accessed by the mobile communication terminal 10 and a latitude/longitude value representing a current position of the data collection device may be performed.

In an embodiment, after step S230, a step of concatenating an output of the neighboring cell inference model 51 with an input of the precise position inference model 52 by using the combination module 126 of the model training device 120 may be further performed.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A precise positioning method performed by a precise positioning apparatus, the precise positioning method comprising:
a step of receiving a serving cell identifier (ID) from a mobile communication terminal by using a communication device;
a step of analyzing the serving cell ID to infer a neighboring cell ID by using a neighboring cell inference model; and
a step of analyzing the neighboring cell ID to infer a position of the mobile communication terminal by using a precise position inference model.

2. The precise positioning method of claim 1, wherein the neighboring cell inference model is a deep learning network previously learning a relationship between the serving cell ID and the neighboring cell ID.

3. The precise positioning method of claim 1, wherein the precise position inference model is a deep learning network previously learning a relationship between the neighboring cell ID and a precise position of the mobile communication terminal.

4. The precise positioning method of claim 1, further comprising a step of preprocessing the serving cell ID, between the step of receiving the serving cell ID and the step of inferring the neighboring cell ID,
the preprocessing step comprises:
a step of converting the serving cell ID from character-type data into integer-type data through a tokenization process;
a step of adjusting a size of the integer-type data through a padding process; and
a step of inputting the size-adjusted integer-type data to the neighboring cell inference model.

5. The precise positioning method of claim 4, wherein the step of inferring the neighboring cell ID comprises:
a step of analyzing the size-adjusted integer-type data to obtain a neighboring cell ID token which is highest in right answer probability; and
a step of obtaining the neighboring cell ID from the neighboring cell ID token through a reverse tokenization process.

6. The precise positioning method of claim 1, further comprising a step of preprocessing the neighboring cell ID, between the step of inferring the neighboring cell ID and the step of inferring the position of the mobile communication terminal,
the step of preprocessing the neighboring cell ID comprises:
a step of converting the neighboring cell ID from character-type data into integer-type data through a tokenization process;
a step of adjusting a size of the integer-type data through a padding process; and
a step of inputting the size-adjusted integer-type data to the precise position inference model.

7. The precise positioning method of claim 6, wherein the step of inferring the position of the mobile communication terminal comprises:
a step of analyzing the size-adjusted integer-type data to obtain a grid code token which is highest in right answer probability;
a step of obtaining a grid code from the grid code token through a reverse tokenization process; and
a step of converting the grid code into a position of the mobile communication terminal including a latitude value and a longitude value through a data post-processing process.

8. A training method of a deep learning model performed by a model training device and including a neighboring cell inference model and a precise position inference model inferring a position of a mobile communication terminal from a serving cell identifier (ID) received from the mobile communication terminal, the training method comprising:
a step of receiving a training data set from a data collection device moving by using a communication device of the model training device;
a step of training the neighboring cell inference model to infer a neighboring cell ID from a serving cell ID by using a first training module of the model training device, based on the serving cell ID and the neighboring cell ID included in the training data set; and
a step of training the precise position inference model to infer a position of the mobile communication terminal from the neighboring cell ID by using a second training module of the model training device, based on a serving cell ID, a neighboring cell ID, and a mobile network code of a mobile communication base station accessed by the data collection device and included in the training data set and a latitude or longitude value representing a current position of the data collection device.

9. The training method of claim 8, further comprising, after the step of training the precise position inference model, a step of concatenating an output of the neighboring cell inference model with an input of the precise position inference model by using a combination module of the model training device.

10. A precise positioning apparatus comprising:
a processor;
a communication device configured to receive a serving cell identifier (ID) from a mobile communication terminal, based on control by the processor;
a storage device configured to store a neighboring cell inference model analyzing the serving cell ID to infer a neighboring cell ID and a precise position inference model analyzing the neighboring cell ID to infer a position of the mobile communication terminal, based on execution of the processor.

11. The precise positioning apparatus of claim 10, wherein the neighboring cell inference model is a deep learning network previously learning a relationship between the serving cell ID and the neighboring cell ID.

12. The precise positioning apparatus of claim 10, wherein the precise position inference model is a deep learning network previously learning a relationship between the neighboring cell ID and a precise position of the mobile communication terminal.

13. The precise positioning apparatus of claim 10, wherein a data preprocessor is further stored in the storage device, and
the data preprocessor converts the serving cell ID from character-type data into integer-type data through a tokenization process, adjusts a size of the integer-type data through a padding process, and inputs the size-adjusted integer-type data to the neighboring cell inference model.

14. The precise positioning apparatus of claim 10, wherein a data preprocessor is further stored in the storage device, and
the data preprocessor converts the neighboring cell ID from character-type data into integer-type data through a tokenization process, adjusts a size of the integer-type data through a padding process, and inputs the size-adjusted integer-type data to the precise position inference model.
